(19) United States
(12) Patent Application Publication
(10) Pub. No.: US 2011/0290723 A1
(43) Pub. Date: Dec. 1, 2011

(54) METHOD AND PLANT FOR MANAGING THE CLOGGING OF MEMBRANE MODULES AND FILTRATION MEMBRANES

(75) Inventors: Véronique Bonnelye, Conflans Sainte Honorine (FR); Francisco Fernandez Lopez, Santander (ES)

(73) Assignee: Degremont, Rueil-Malmaison (FR)

(21) Appl. No.: 13/141,769

(22) PCT Filed: Dec. 17, 2009
(86) PCT No.: PCT/IB09/55807

§ 371 Date: Aug. 15, 2011

(30) Foreign Application Priority Data
Dec. 23, 2008 (FR) 08/07390

(51) Int. Cl. B01D 65/08

(52) U.S. Cl. 210/636; 210/85

(57) ABSTRACT

The invention relates to a method for managing the plugging of membrane modules and of filtration membranes, in particular for nanofiltration, ultrafiltration or reverse osmosis for desalinating water, which comprises carrying out consecutive rinsing operations for controlling clogging, in particular biological clogging: evaluating the thickness of the biofilm; starting a rinsing operation at the latest when the evaluated thickness of the biofilm exceeds a first predetermined setpoint value for the biofilm thickness and stopping the rinsing operation not before the biofilm thickness has become lower than a second predetermined setpoint value lower than the first one for the biofilm thickness.

### TECHNICAL FIELD

The invention relates to a method for managing the fouling of membrane modules and filtration membranes, more especially nanofiltration, ultrafiltration or reverse-osmosis membranes, for water desalination.

Water desalination systems are generally of the type consisting of spiral modules comprising at least one membrane element employing a desalination membrane and spacers (see in particular: “Mémento Technique de l'Eau [Water Technical Memorandum]”, published by DEGREMONT, 10th edition, volume 2, pages 1042-1044).

Desalination membranes are used for separating compounds dissolved in a solvent. In the case of seawater or brackish water desalination, the solvent is water and the dissolved compounds are chloride, sodium, sulfate, calcium and magnesium ions and any other ions present in natural or industrial water, and also organic molecules, organic matter and organic micropollutants such as pesticides and herbicides, this list not being exhaustive.

These desalination membranes are sensitive to fouling, and especially to biological fouling or biofouling: microorganisms colonize the surface of the membranes and the constituents of the membrane molecules, such as the spacers (mesh spacers made of composite materials necessary for maintaining the spacing between two membranes of a spiral module and for maintaining good hydraulic behavior of the membrane elements). The fouling may also be caused by mineral compounds, clay particles, iron-based or manganese-based precipitates.

The fouling of desalination membranes causes the operation of the system to be modified in a number of ways:
the fouling disturbs the flow along the desalination membrane, reduces the effect of the spacer and leads to an increase in the polarization layer on the surface of the membrane. This polarization layer—the area where the compounds obtained by the membrane accumulate—causes an increase in the concentration and therefore in the osmotic pressure at the surface of the membrane and therefore leads to a reduction in the effective filtration pressure, hence a lower production. The increase in the polarization layer thus leads to higher salt concentrations in the vicinity of the desalination membrane and therefore an increase in the risk of supersaturated salts precipitating. This results either in the precipitation of salts, hence more rapid fouling of the desalination membranes, or an overconsumption of reagents used to avoid/retard this precipitation;
the fouling disturbs the flow along the desalination membrane, causes an increase in the pressure drop between the feed and the concentrate discharge, which pressure drop causes a reduction in the pressure available for filtration, hence a loss of production at constant pressure. Above a certain pressure drop value, since the strength of the materials constituting the membrane element has been exceeded, there may be irreversible mechanical damage to the membrane element.

### PRIOR ART

a) To limit the fouling and biofouling of reverse-osmosis membranes, systems for pretreating the feedwater supplying the membrane elements are employed.
b) When the membrane elements and the membranes themselves are fouled, it is necessary to remove the fouling layer so that the system recovers its performance in terms of production and consumed energy. Removal of the fouling layer is generally accomplished by chemical washing: application of acid or basic solutions containing surfactants and/or biocides or bacteriostatic agents.
c) Another method consists in generating a hypersaline osmotic shock by sending a brine of higher concentration than the concentration of the feedwater to be treated onto the membrane on the concentration side (French patent application No. 08/03591 filed on Jun. 26, 2008 in the name of the same filing company).
d) Another method consists in generating an osmotic shock by applying a hyposaline solution. The bacteria that grow in the feedwater supply in the desalination system and on the concentrate side of the membrane have developed a metabolism resistant to high osmotic pressures. Contact with water of very low osmotic pressure causes a direct osmosis effect and bacterial cell lysis and rupture.

### Drawbacks of the Known Methods

The various methods mentioned above have drawbacks, the main ones of which are mentioned below for each method, in paragraphs denoted by the same letters as for the method in question.

a) These systems, of variable effectiveness, do limit the fouling effect, but do not completely eliminate it.
b) The main drawback of chemical washing is the need to stop production during this phase. It is also necessary to provide washing solutions (acid or basic reagents, biocides or bacteriostatic agents, surface-active reagents) on the plant. This solution generates discharges that have to be removed. Moreover, chemical washing requires the use of low-hardness water (hardness less than 50 mg of CaCO₃ per liter). Reverse-osmosis permeate (desalinated water) is generally used for this purpose, whereby reducing the productivity of the desalination system. Owing to the geometry of the elements containing the membranes, which are very compact, the washing is rarely 100% effective and residual fouling progressively builds up until the washing operation can no longer recover the performance necessary to operate the system (necessary pressure above the pressure available in the system; mechanical rupture of the elements as a result of the pressure drop limit being exceeded). In addition, application of these washing solutions, although it does dissolve and transport the fouling matter away from the membrane element, does progressively attack the membrane itself and therefore results in a loss of performance of the desalination action (embrittlement of the polymer of which the membrane is composed; opening of the pores, reduction in salt rejection; compacting; loss of permeability and loss of production).
c) The main drawback of a hypersaline osmotic shock is the need to stop the production during this phase. It is also necessary in the plant to provide a hypersaline solution, which results in discharges that have to be removed.
d) The main drawback of an osmotic shock by applying water of very low salinity to rinse the concentrate side of the membranes is the consumption of desalinated water, which has an impact on the productivity of the desalination plant. The osmotic shocks are generally produced very frequently, in a preventative manner, in order to avoid degrading the hydraulic parameters, the degradation of the hydraulic parameters being only slightly affected by these osmotic shocks. This high frequency results in a large consumption of low-salinity water.

### SUMMARY OF THE INVENTION

The object of the invention is most particularly to provide a method for managing the fouling of membrane modules and filtration modules, more especially nanofiltration, ultrafiltration or reverse-osmosis membranes, for water desalination, which makes it possible to alleviate the drawbacks of the various aforementioned methods of managing the fouling.

The object of the invention is especially to provide a method for managing the fouling of membrane modules that makes it possible to improve the production of filtered water while still maintaining the lifetime of the membranes and limiting the consumption of rinsing water.

The method for managing the fouling of membrane modules and filtration modules, more especially nanofiltration, ultrafiltration or reverse-osmosis membranes, for water desalination, consists according to the invention in carrying out successive rinsing operations on the membrane module and on the membrane(s) in order to combat the fouling, in particular the biofouling, and is characterized in that:
the thickness of the biofilm is measured;
a rinsing operation is triggered at the latest when the measured thickness of the biofilm exceeds a first predefined setpoint value for the thickness of the biofilm; and
the rinsing operation is stopped at the earliest when the thickness of the biofilm has become less than a second predetermined setpoint value, lower than the first, for the thickness of the biofilm.

Advantageously, the pressure drop of the membrane element is measured and:
a rinsing operation is triggered at the latest when the pressure drop exceeds a first predetermined setpoint value for the pressure drop; and
the rinsing operation is stopped at the earliest when the pressure drop has become less than a second setpoint value, lower than the first, for the pressure drop.

Advantageously, the productivity of the membrane element, which takes account of the state of fouling of the membrane surface, is measured and a rinsing operation is triggered at the latest when the productivity becomes less than a predetermined setpoint for the productivity.

Preferably, the rinsing operations are carried out with low-salinity water, typically having a salinity of less than 1/10^{th} (one tenth) of the salinity of the feedwater supplying the system in production phase.

Thus, in the case in which the following three parameters:
the thickness of the biofilm, the pressure drop and
the productivity of the membrane element are taken into account:
the rinsing operation is triggered as soon as the setpoint value of one of these three parameters is reached; and
the rinsing operation is stopped as soon as the second setpoint value for one of the following two parameters is reached:
the thickness of the biofilm; and
the pressure drop.

The thickness of the biofilm may be measured continuously, or periodically, by a probe inserted into the feedwater circuit for supplying the water to be filtered or into the concentrate circuit, the biofilm that grows on the probe being a good representation of the biofilm that grows on the membrane elements. The thickness of the biofilm may be measured on the basis of the change in electrical or thermal conductivity of the surface of the probe. The material of the probe is selected to be similar in its surface finish to that of the desalination membrane on which the microorganisms grow.

The invention thus provides a method for combating the fouling and biofouling that has fewer constraints, since the rinsing operation is carried out with low-salinity water, while limiting both the rinsing frequency and rinsing duration just sufficiently, depending on the specific parameters, thereby reducing the time devoted to rinsing and the consumption of rinsing water, while still maintaining good productivity.

The parameters taken into consideration, which account for the fouling of the system, are of three types:
the thickness of the biofilm measured by a specific sensor dedicated for this purpose. The sensor consists of a probe which is inserted into the feedwater circuit or the concentrate circuit and is used for continuously measuring the thickness of the biofilm that grows on the surface of the probe;
the pressure drop of the membrane element, which accounts for the state of fouling of the membrane surface. The pressure drop corresponds to the pressure difference on either side of the membrane element, i.e. the pressure difference between the concentrate part and the feed part. This pressure drop is normalized with respect to the hydraulic and temperature conditions; and
the productivity of the membrane element. The productivity corresponds to the output of filtered water produced by the desalination system and is normalized with respect to standard salinity and temperature conditions (according to the ASTM D4516 standard).

The invention also relates to a plant for implementing the method defined above, comprising at least one membrane module or filtration membrane, a feedwater supply line, an outlet for the concentrate and an outlet for the treated water or filtrate, characterized in that it includes a probe inserted into the feedwater circuit for supplying water to be filtered or into the concentrate circuit in order to measure the thickness of the biofilm.

The thickness of the biofilm may be measured on the basis of the change in electrical or thermal conductivity of the surface of the probe. The material of the probe is selected to be similar in its surface finish to that of the desalination membrane on which the microorganisms grow.

The invention consists, apart from the abovementioned arrangements, of a number of other arrangements which will be more explicitly addressed hereinafter with regard to an illustrative example described with reference to the appended drawings but not in any way limiting.

### BRIEF DESCRIPTION OF THE DRAWINGS

In the drawings:

FIG. 1 is a partial diagram of a water treatment plant employing the method of the invention;

FIG. 2 is a schematic cross section, on a smaller scale, of a filtration unit comprising four spiral modules in series;

FIG. 3 is a cross section, on a larger scale, on the line III-III of FIG. 4 of a spiral membrane module of the plant of FIG. 1;

FIG. 4 is a longitudinal section, on a smaller scale, on the line IV-IV of FIG. 3 of the spiral module;

FIG. 5 is a graph illustrating the results obtained with a pilot filtration unit operating according to the method of the invention, the time expressed in weeks being plotted on the x-axis and various quantities being plotted on the y-axes;

FIG. 6 is a graph illustrating, in the same way as FIG. 5, the results obtained with a pilot filtration unit, the method of managing the membrane fouling of which is a conventional method with chemical washing; and

FIG. 7 is a graph similar to that of FIG. 5 for a filtration unit employed with a conventional method of managing the fouling by rinsing with weakly saline water.

### DETAILED DESCRIPTION OF THE INVENTION

The description is given with reference to spiral membranes, but the method of the invention applies to all filtration membranes, especially hollow-fiber membranes or planar membranes.

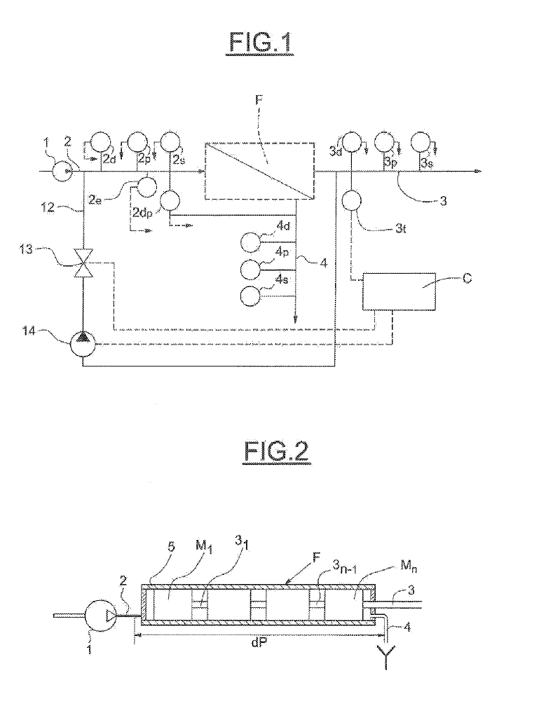

FIG. 1 of the drawings shows a water, particularly seawater, desalination plant comprising a membrane filtration unit F. The raw water is supplied by a pump 1, the outlet of which is connected, via a line 2, to the inlet of the filtration unit F. The filtered water, also called the permeate, leaves the unit F via a line 3. The concentrate, which corresponds to the fraction retained by the unit F, is discharged via a line 4.

Installed on the supply line 2 are:
a flowmeter 2d giving the feedwater flow rate;
a pressure sensor 2p giving the pressure of the feedwater at the inlet of the filtration unit; and
a salinity sensor 2s giving the salinity of the feedwater.

Installed on the line 3 are:
a flowmeter 3d giving the permeate flow rate;
a pressure sensor 3p giving the pressure of the permeate;
a salinity sensor 3s giving the salinity of the permeate; and
a temperature sensor 3t giving the temperature of the permeate.

Installed on the concentrate discharge line 4 are:
a flowmeter 4d giving the flow rate of the concentrate;
a pressure sensor 4p giving the pressure of the concentrate; and
a salinity sensor 4s giving the salinity of the concentrate.

All the information delivered by these sensors is sent to a control unit C, for example, a microcomputer programmed appropriately.

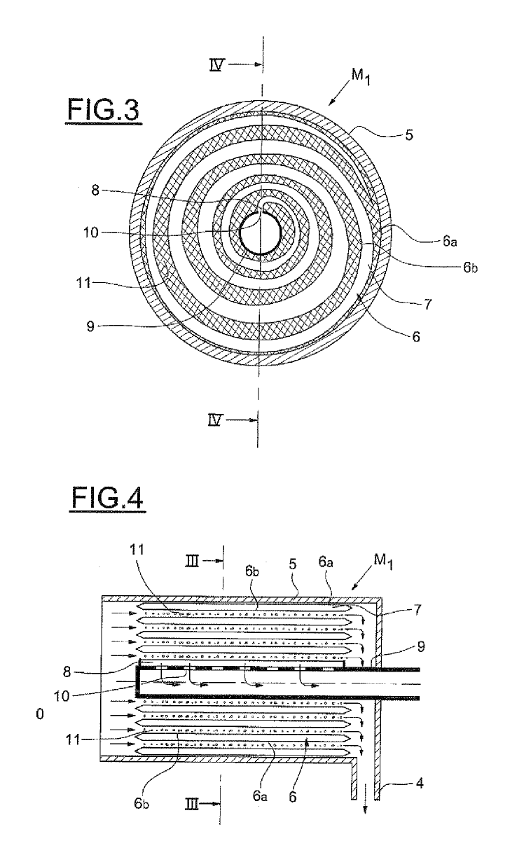

The filtration unit F as illustrated in FIG. 3 is advantageously made up of several spiral modules M₁ . . . Mₙ arranged in series in a cylindrical casing 5. Such spiral membrane modules are known and described in particular in “Mémento Technique de l'Eau” published by Degremont, 10th edition, Volume 2, pages 1042-1043. For clarity of the explanation, the description of a spiral module M₁ is recalled below. The other modules connected in series are similar. The number n of modules of a unit F is generally between 4 and 8, limits inclusive.

The module M₁ is shown respectively on a larger scale in FIGS. 3 and 4.

This module comprises at least one membrane element 6 wound in a spiral. The membrane element 6 is formed by a sandwich consisting of two planar filtration membranes 6a, 6b of rectangular outline. A flexible porous sheet 7, also called a collector, is placed between the two planar membranes 6a, 6b. The sandwich thus formed is sealed along the three edges of the rectangular planar membrane 6a, 6b. The edge 8 of the sandwich, which remains open, is welded to a cylindrical collector tube 9 on either side of a generatrix pierced with holes 10.

Several sandwiches may thus be formed, these being fastened to the tube 9 along a generatrix specific to the sandwich in question. The assembly is wound up in a spiral around the tube 9, the sandwiches being separated from one another by a spacer 11, formed especially by a mesh of flexible plastic. To simplify the drawings, only a single membrane element 6 is shown in FIGS. 3 and 4, wound in a spiral, with the spacer 11 between the various turns of the spiral. The raw water to be treated flows into the spacer 11 parallel to the collector tube 9. The permeate flows substantially radially through the membranes 6a, 6b. The porous sheet 7 of the sandwich drains the permeate as far as the open edge 8 of the sandwich in order to be discharged via the axial collector tube 9.

The fouling, especially biofouling, may thus affect not only the membranes 6a, 6b but also the spacer 11.

According to the invention, the thickness of the biofilm that forms on the membranes 6a, 6b and on the spacer 11 is continuously measured by a sensor 2e consisting of a probe installed in situ, in contact with the raw water, being mounted on the line 2 as illustrated in FIG. 1 and/or another probe (not shown) in contact with the concentrate, being mounted on the line 4. The measurement is based on the change in the surface conductivity of the probe. The quantities measured may be an electrical or thermal conductivity, especially using a multi-electrode conductimetric microsensor from the company Neosens (French patent No. 2 911 186).

The material of the probe is chosen to have a surface finish as close as possible to that of the desalination membranes 6a, 6b on which the microorganisms grow. The signal is measured continuously, or periodically at variable intervals, depending on the sensitivity of the medium so as to promote growth of the biofilm, especially by taking into account the temperature, when this is high, and the presence of nutrients.

A sensor 2dP is installed between the inlet of the filtration unit F, on the line 2, and the outlet for the concentrate on the line 4 in order to deliver the pressure drop dP corresponding to the difference in pressure between the inlet of the filtration unit and the outlet of the concentrate. This pressure drop dP corresponds to that created by the spacer 11 during flow of the raw water, which concentrates while polluting, as far as the outlet 4. The value of this pressure drop dP is sent to the control unit C and is normalized with respect to the viscosity, to the filtration rate and to the concentrate flow rate.

The permeate flow rate is normalized according to the AST D 4516-00 standard.

The method for managing the fouling of filtration membranes according to the invention is the following.

The biofilm that grows on the probe of the sensor 2e is a good representation of the biofilm that grows on the membrane elements of the filtration unit F.

A maximum admissible setpoint value for the thickness of the biofilm is determined, especially according to experiment, overshooting of this maximum setpoint having to trigger a membrane rinsing operation. Also determined is a minimum setpoint value for this biofilm thickness, the undershooting of which must cause the rinsing to stop.

Likewise, a maximum setpoint value for the pressure drop dp, the overshooting of which must trigger membrane rinsing, and a minimum setpoint value, the undershooting of which must stop the rinsing, are determined.

Finally, for the productivity of the filtration unit, corresponding to the permeate flow rate measured by the flowmeter 3d, a minimum setpoint value is determined for which the membrane rinsing must be triggered when this setpoint is undershot.

These various setpoint values are stored in memory in the control unit C, which may compare the information coming from the various sensors with these setpoint values.

The rinsing is preferably carried out with desalinated water, generally produced by the desalination plant. For example, a bypass line 12 (FIG. 1) brings a controlled flow of filtered water taken from the permeate on the line 3 back to the inlet of the filtration unit F. A solenoid valve 13 and a recirculation pump 14, both installed on the line 12, are operated by the unit C when a rinsing operation is necessary.

The rinsing is controlled according to the three control parameters consisting respectively of the thickness of the biofilm, the pressure drop and the productivity.

The rinsing is triggered:
as soon as the thickness of the biofilm or the pressure drop exceeds its respective maximum setpoint value; or
as soon as the productivity falls below its minimum setpoint value.

Thus, if the thickness of the biofilm reaches the maximum setpoint value even before the pressure drop dP has reached its maximum value, the rinsing operation is triggered. The same applies if one of the other two parameters reaches its setpoint value first: it is this parameter that triggers the rinsing.

In the example illustrated in FIG. 1, the rinsing is carried out by opening the valve 13 controlled by the unit C.

The rinsing time is determined by the change in the two parameters, namely the thickness of the biofilm and the flow pressure drop, during the rinsing phase.

If the thickness of the biofilm has decreased sufficiently to undershoot the minimum setpoint value, even before the pressure drop has reached its minimum value, the rinsing operation is stopped. The same applies if the flow pressure drop has reached its minimum setpoint value before the thickness of the biofilm has reached its minimum setpoint value.

The method of the invention makes it possible for the frequency of washing with treated water (soft water) to be optimally managed and for the consumption of soft water to be reduced, while still avoiding production stoppages.

Although rinsing with soft water is preferred, the method of the invention may also apply to rinsing with hypersaline water.

### Experimental Results

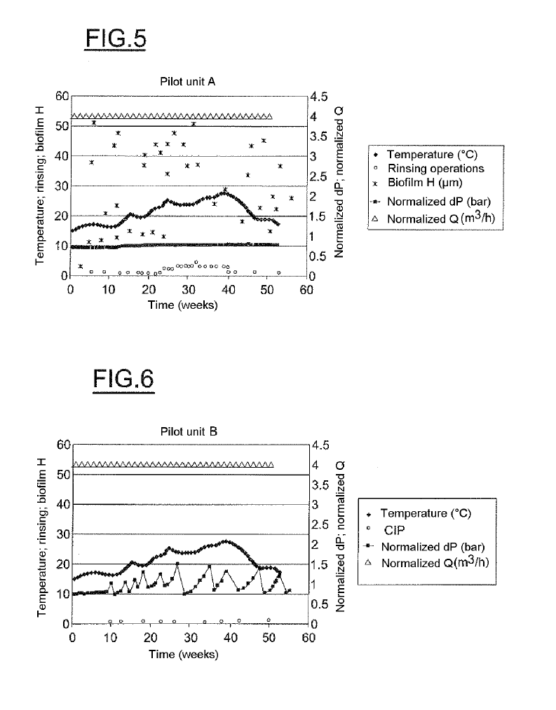

The method of the invention was implemented on a pilot unit A treating seawater, with the objective of producing drinking water. The results obtained with this pilot unit A are given in the graph of FIG. 5.

The time in weeks is plotted on the x-axis, the experiment lasting one year. Seen on the y-axis on the left-hand side are: the temperature of the water in ° C., represented by filled diamond symbols with a vertical diagonal; the number of rinsing operations, represented by circles; and the thickness H of the biofilm in microns, represented by crosses. Plotted on the y-axis on the right-hand side are: the normalized dP pressure drop values, expressed in bar and represented by filled squares; and the normalized flow rate Q or productivity, expressed in m³/h and represented by triangles.

At the same time as this pilot unit A, a pilot unit B was operated, for the same time and under the same conditions, with the fouling being controlled by chemical washing operations, the results of which are given in FIG. 6 with the same x-axis and y-axis parameters, with the exception of the biofilm thickness, which was not measured in this method.

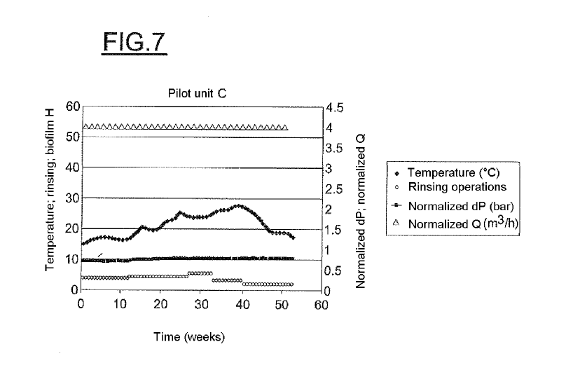

Another pilot unit, C, was operated under the same conditions with the fouling being controlled by rinsing with slightly saline water, and the results are given in FIG. 7.

The pressure drop dP (FIG. 2) corresponds to the difference in pressure between the inlet of the membrane element and the outlet for the concentrated water at its end, normalized with respect to the viscosity, to the filtration rate and to the concentrate flow rate.

The normalized flow rate corresponds to the permeate flow rate normalized according to the ASTD 4516-00 standard.

The seawater treated is characterized by the following parameters during the period of the trials:
total salinity: 38.2 to 38.9 g/1;
temperature: 15 to 26° C.;
pH: 8.1 to 8.2;
dissolved organic carbon: 2.8 to 4.2 mg/l; and
bacteria (epifluorescence measurement): 4×10⁴ to 10⁵/ml.

The plant comprises three pilot units, namely small-capacity (4 m³/h unitary) desalination systems supplied with the same water. Pretreatment of the desalination units is carried out by ultrafiltration—one of the most advanced pretreatment processes in water pretreatment,—for the purpose of desalinating it. Ultrafiltration makes it possible in fact to eliminate more than 4 log microorganisms between the raw water to be desalinated and after pretreatment. Despite this pretreatment, a drift in the operating parameters of the desalination units is observed after a few weeks of operation.

The pilot unit A is equipped with the biofouling control system according to the invention. The parameters governing the frequency of rinsing with desalinated water are indicated below:
maximum normalized pressure drop: 0.75 bar;
minimum normalized flow rate: 4.02 m³/h;
maximum biofilm thickness: 50 μm.

The other two pilot units are managed using conventional fouling control methods (chemical washing in the case of the pilot unit B and rinsing with slightly saline water in the case of the pilot unit C). Chemical washing is carried out when the normalized pressure drop increases by more than 15% or when the normalized flow rate drops by more than 10%. Rinsing with slightly saline water is carried out with a frequency adjusted according to the temperature.

The rinsing with desalinated water lasts 10 minutes and consumes 1.5 m³ or 0.75 m³ depending on the optimization.

The chemical washing lasts 12 hours and consumes 45 m³.

FIGS. 5, 6 and 7 show the results of monitoring the operation of the pilot units A, B and C over a period of one year. After this period of operation, a hydraulic production assessment was carried out. The production of the pilot unit A, managed with the automatic osmotic-shock system, reached a production of 36 025 m³, whereas the pilot unit B, subjected to periodic chemical washing operations, produced only 32 475 m³ while pilot unit C, subjected to rinsing with slightly saline water, carried out preventatively, produced 35 218 m³.

1. A method of managing the fouling of membrane molecules and filtration membranes, more especially nanofiltration, ultrafiltration or reverse osmosis membranes, for water desalination, according to which successive rinsing operations are carried out in order to combat the fouling, in particular the biofouling, wherein:
the thickness of the biofilm is measured by a probe inserted into the feedwater circuit for supplying water to be filtered or into the concentrate circuit, the biofilm that grows on the probe being a good representation of the biofilm that grows on the membrane elements;
a rinsing operation is triggered at the latest when the measured thickness of the biofilm exceeds a first predefined setpoint value for the thickness of the biofilm; and
the rinsing operation is stopped at the earliest when the thickness of the biofilm has become less than a second predetermined setpoint value, lower than the first, for the thickness of the biofilm.

2. The method as claimed in claim 1, wherein the material of the probe is selected to be similar in its surface finish to that of the desalination membrane on which the microorganisms grow.

3. The method as claimed in claim 1, wherein the thickness of the biofilm is measured continuously.

4. The method as claimed in claim 1, wherein the thickness of the biofilm is measured periodically.

5. The method as claimed in claim 1, wherein the pressure drop of the membrane element is measured and:
a rinsing operation is triggered at the latest when the pressure drop exceeds a first predetermined setpoint value for the pressure drop; and
the rinsing operation is stopped at the earliest when the pressure drop has become less than a second setpoint value, lower than the first, for the pressure drop.

6. The method as claimed in claim 1, wherein the productivity of the membrane element, which takes account of the state of fouling of the membrane surface, is measured and a rinsing operation is triggered at the latest when the productivity becomes less than a predetermined setpoint for the productivity.

7. The method as claimed in claim 1, wherein the rinsing operations are carried out with low-salinity water, typically having a salinity of less than 1/10^{th} (one tenth) of the salinity of the feedwater supplying the system in production phase.

8. The method as claimed in claim 1, wherein the thickness of the biofilm is measured on the basis of the change in electrical or thermal conductivity of the surface of the probe.

9. A plant for implementing a method as claimed in claim 1, comprising at least one membrane module or filtration membrane, a feedwater supply line, an outlet for the concentrate and an outlet for the treated water or filtrate, characterized in that it includes a probe inserted into the feedwater circuit for supplying water to be filtered or into the concentrate circuit in order to measure the thickness of the biofilm, the biofilm that grows on the probe being a good representation of the biofilm that grows on the membrane elements.

10. The plant as claimed in claim 9, characterized in that the thickness of the biofilm is measured on the basis of the change in electrical or thermal conductivity of the surface of the probe.

11. The plant as claimed in claim 9, wherein the material of the probe is selected to be similar in its surface finish to that of the desalination membrane on which the microorganisms grow.
